(19) United States
(12) Patent Application Publication
(10) Pub. No.: US 2014/0347735 A1
(43) Pub. Date: Nov. 27, 2014

(54) ETALON AND METHOD FOR PRODUCING ETALON

(71) Applicant: KYOCERA CRYSTAL DEVICE CORPORATION, Higashine-shi, Yamagata (JP)

(72) Inventors: Kotaro Wakabayashi, Higashine-shi (JP); Yukiko Furukata, Higashine-shi (JP)

(73) Assignee: KYOCERA CRYSTAL DEVICE CORPORATION, Higashine-shi, Yamagata (JP)

(21) Appl. No.: 14/371,342

(22) PCT Filed: Dec. 17, 2012
(86) PCT No.: PCT/JP2012/082647

§ 371 Date: Jul. 9, 2014

(30) Foreign Application Priority Data
May 15, 2012 (JP) 2012-111530

(51) Int. Cl. G02B 5/28; G02B 1/11

(52) U.S. Cl. CPC G02B 5/284; G02B 1/11
USPC 359/580; 29/428; 29/407.05

(57) ABSTRACT

The etalon has a first light transmission body which causes a positive change in a light path length with respect to a temperature increase change, a second light transmission body which causes a negative change in a light path length with respect to a temperature increase change, a first reflection film which covers a first outer surface, a first anti-reflection film which covers a first inner surface, a second anti-reflection film which cover a second inner surface, and a second reflection film which covers a second outer surface. The first inner surface and the second inner surface face each other across a gap there between.

### TECHNICAL FIELD

The present invention relates to an etalon used in a laser system, an optical communication system or the like and a method for producing the same.

### BACKGROUND ART

Known in the art is a composite type etalon which is designed so that a change in characteristics due to temperature change is suppressed (see for example Patent Literature 1). In this composite type etalon, a flat plate-shaped light transmission body is configured comprised of a thin transparent plate which causes a positive change in a light path length with respect to a temperature increase change and a thin transparent plate which causes a negative change in the light path length with respect to a temperature increase change bonded each other. Note that the light path length is represented by “nd” when the light passes through a medium having a refractive index of “n” for a distance “d”. One surface of the light transmission body is formed as an incidence face, while the other surface is formed as an emission face, and reflection films are provided on the incidence face and the emission face. Between the thin transparent plates, an anti-reflection film is provided.

In the composite type etalon described above, changes in the light path lengths of the thin transparent plates due to a temperature change are cancelled each other, so a change in the characteristics due to the temperature change is suppressed. Further, according to Patent Literature 1, due to provision of the anti-reflection film between the thin transparent plates, the waveform of the spectrum of the intensity of the light which passes through the etalon becomes periodic. Further, it is considered that the maximum values and the minimum values match.

### CITATIONS LIST

### Patent Literature

Patent Literature 1: Japanese Patent Publication No. 2005-10734A

### SUMMARY OF INVENTION

### Technical Problem

In the composite type etalon as described above, however, various problems arise. For example, since an anti-reflection film is provided between the thin transparent plates, the reflectance cannot be correctly grasped until the thin transparent plates are bonded to each other. For example, even if the reflectance of the anti-reflection film is measured before the thin transparent plates are bonded, the physical properties and film thickness of the anti-reflection film are liable to change due to the bonding, therefore the reflectance is liable to change. As a result, for example, even measuring the reflectance of the anti-reflection film before bonding the thin transparent plates so as to try to avoid bonding of the thin transparent plates having problems in the anti-reflection films, the final product is liable to become defective. The reverse situation may also occur.

An object of the present invention is to provide a new type of etalon and a method for producing the same.

### Solution to Problem

An etalon according to one aspect of the present invention has a first light transmission body which has a first outer surface which configures one of an incidence face and emission face, which has a first inner surface of the back surface of the first outer surface, and which causes a positive change in a light path length with respect to a temperature increase change; a second light transmission body which has a second outer surface which configures the other of the incidence face and the emission face, which has a second inner surface of the back surface of the second outer surface, and which causes a negative change in a light path length with respect to a temperature increase change; a first reflection film which covers the first outer surface; a first anti-reflection film which covers the first inner surface; a second reflection film which covers the second outer surface; and a second anti-reflection film which cover the second inner surface. The first inner surface and the second inner surface face each other across a gap therebetween.

A method for producing an etalon according to an aspect of the present invention has a step of preparing a first light transmission body which has a first outer surface and a first inner surface of the back surface of the first outer surface and which causes a positive change in a light path length with respect to a temperature increase change, a step of preparing a second light transmission body which has a second outer surface and a second inner surface of the back surface of the second outer surface and which causes a negative change in the light path length with respect to a temperature increase change, a step of forming a first reflection film covering the first outer surface, a step of forming a first anti-reflection film which covers the first inner surface, a step of forming a second reflection film which covers the second outer surface, a step of forming a second anti-reflection film which covers the second inner surface, and a step of fixing the first light transmission body and the second light transmission body to each other in a state where the first inner surface which is covered by the first anti-reflection film and the second inner surface which is covered by the second anti-reflection film are made to face each other across a gap.

### Advantageous Effects of Invention

According to the above configuration or routine, a new type of etalon can be provided.

### BRIEF DESCRIPTION OF DRAWINGS

FIG. 1 is a side view which schematically shows an etalon according to an embodiment of the present invention.

FIG. 2 is a diagram which schematically shows a transmission characteristic of the etalon.

FIG. 3 is a flow chart which shows a procedure of a method of producing the etalon in FIG. 1.

FIG. 4 is a table for explaining etalons according to comparative examples and working examples.

FIG. 5 is a block diagram which shows an example of application of an etalon.

### DESCRIPTION OF EMBODIMENTS

(Configuration of Etalon)

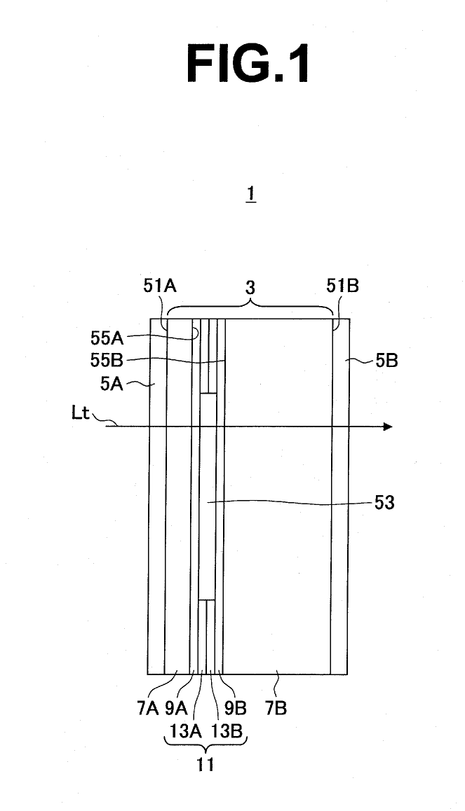

FIG. 1 is a side view or cross-sectional view which schematically shows an etalon 1 according to an embodiment of the present invention.

The etalon has a light transmitting portion 3 which has a first outer surface 51A and a second outer surface 51B which are parallel to each other, a first reflection film 5A which is provided on the first outer surface 51A, and a second reflection film 5B which is provided on the second outer surface 51B.

Note that, below, for configurations with “first” and “A” or “second” and “B”, the “first” and “A” etc. will sometimes be omitted. For example, sometimes the first outer surface 51A and second outer surface 51B will be simply referred to as the “outer surfaces Si”, and the two will not be distinguished.

One of the pair of outer surfaces 51 (the first outer surface 51A in the example in FIG. 1) configures the incidence face of light Lt, while the other (second outer surface 51B in the example in FIG. 1) configures the emission face of the light Lt. The light Lt which strikes the light transmitting portion 3 is repeatedly reflected between the pair of reflection films 5. Only light having a predetermined frequency defined according to the light path length of the light transmitting portion 3 is emitted. Note that, FIG. 1 illustrates a case where the light Lt vertically strikes the incidence face. However, the light Lt may strike the incidence face at a slant as well.

The light transmitting portion 3 has a first light transmission body 7A, a second light transmission body 7B which faces the first light transmission body 7A with a gap 53 therebetween, a first anti-reflection film 9A which is positioned on the gap 53 side of the first light transmission body 7A, a second anti-reflection film 9B which is positioned on the gap 53 side of the second light transmission body 7B, and a spacer 11 which is interposed between the pair of light transmission bodies 7 (in more detail, between the pair of anti-reflection films 9).

The first light transmission body 7A has the already explained first outer surface 51A and a first inner surface 55A which forms the back surface of the first outer surface 51A. The second light transmission body 7B has the already explained second outer surface 51B and a second inner surface 55B which forms the back surface of the second outer surface 51B. Further, the first inner surface 55A and the second inner surface 55B face each other while sandwiching the gap 53 therebetween.

In each light transmission body 7, the outer surface 51 and the inner surface 55 are for example parallel. The shape when viewing each light transmission body 7 in the transmission direction of the light Lt (planar shape of the outer surface 51 and inner surface 55) may a rectangle, circle, or other suitable shape. In the pair of light transmission bodies 7, the outer surfaces 51 are parallel to each other as already explained, and the inner surfaces 55 are parallel to each other too.

The thickness etc. of the light transmission bodies 7 may be suitably set in accordance with the desired optical characteristics. For example, the thickness is 100 μm to 2 mm. The surface roughness and degree of parallelism of each surface may be suitably set in accordance with the desired optical characteristics and accuracy. For example, the surface roughness is less than 1 nm, and the degree of parallelism is less than 1 minute. Such a minute surface roughness and high precision degree of parallelism are for example obtained by optical polishing of each surface.

One of the pair of light transmission bodies 7 (determined as the second light transmission body 7B in the present embodiment) is formed by a material by which the change of the light path length with respect to a temperature increase change is positive (the characteristic indicator is positive), and the other (determined as the first light transmission body 7A in the present embodiment) is formed by a material by which the change of the light path length with respect to a temperature increase change is negative (the characteristic indicator is negative). Note that, in FIG. 1, the material having a positive characteristic indicator is positioned on the emission side, and the material having a negative characteristic indicator is positioned on the incidence side. However, the relationships of incidence/emission and positive/negative of characteristic indicators may be reverse to those in FIG. 1. As the material which has a positive characteristic indicator, for example, there can be mentioned crystal quartz (SiO₂). Further, as the material which has a negative characteristic indicator, for example, there can be mentioned strontium titanate (SrTiO₃).

The anti-reflection films 9 are for suppressing reflection at the interfaces between the light transmission bodies 7 and the gap 53. Accordingly, the anti-reflection films 9 are formed so that their light path lengths are close to or match with a quarter wave of the light passing through the etalon 1. More preferably, the anti-reflection films 9 are formed so that their refractive indexes are close to or match with a geometric mean of the refractive indexes of the light transmission bodies 7 which are positioned on the two sides of the anti-reflection films 9 and the gap 53. Note that, at the time of design, as the light path length and refractive index of each medium, use may be made of those at a suitable temperature within an assumed range of working temperature for the etalon 1.

The anti-reflection films 9 for example, while not particularly shown, are configured by laminating a plurality of thin films having refractive indexes which are different from each other. The plurality of thin films are designed in their material, number of layers, and thickness so that the desired optical characteristics (for example reflectance) are obtained. The material of each thin film is for example a dielectric. The dielectric is for example silicon dioxide (SiO₂), titanium dioxide (TiO₂), or tantalum pentoxide (Ta₂O₅). The thickness of each thin film is for example about the submicron level. Further, the thickness of each thin film is made constant in the thin film, and consequently the thickness of each anti-reflection film 9 is constant. The number of layers of the plurality of thin films is for example 10 or less. The plurality of thin films closely contact and are fixed to each other. Further, the anti-reflection films 9 closely contact and are fixed to the light transmission bodies 7.

The spacer 11 contributes to the fastening of the pair of light transmission bodies to each other while keeping the distance of the gap 53 at a suitable size. The spacer 11 is positioned outside of a region for transmitting the light Lt therethrough, that is, on an external edge side of the inner surface 55. For example, the spacer 11 is formed in a ring shape along the periphery of the inner surface 55. The spacer 11 is formed to a constant thickness over its entirety and keeps a pair of inner surfaces 55 (anti-reflection films 9) parallel to each other (keeps the distance of the gap 53 constant).

The spacer 11 is formed by for example a metal layer. More specifically, the spacer 11 has for example a first metal layer 13A which is superimposed on the first anti-reflection film 9A and a second metal layer 13B which is superimposed on the second anti-reflection film 9B.

Each metal layer 13, for example, though not particularly shown, is configured from the anti-reflection film 9 side by lamination of Cr and Au or lamination of Ta and Au. Then, the pair of metal layers 13 are joined to each other by joining the Au to each other by metal diffusion. By employing a laminate structure of Cr or Ta which is strongly joined with an anti-reflection film 9 (or light transmission body 7) and Au capable of strongly joining metals to each other in this way, the pair of light transmission bodies 7 are suitably fastened to each other.

The gap 53 forms a region for passing the light Lt therethrough together with the light transmission bodies 7 and anti-reflection films 9. The gap 53 may be sealed or not sealed. When this is sealed, the interior of the gap 53 may be filled with air or a specific gas or evacuated or substantially evacuated. Further, when air or another gas is filled, the pressure in the gap 53 may be higher or lower than the atmospheric pressure.

The distance of the gap 53 is for example smaller than the thickness of the light transmission bodies 7. For example, the distance of the gap 53 is of the submicron order to the micron order. The gap 53 has a relatively small refractive index compared with the light transmission bodies 7. Therefore, by making the gap 53 relatively small and making the light transmission bodies 7 relatively large, the light transmitting portion 3 can be made smaller as a whole while ensuring the light path length nd. Note that, the distance of the gap 53 may be made larger than the thickness of the light transmission bodies 7 as well.

The reflection films 5, for example, while not particularly shown, are configured by laminating a plurality of thin films having refractive indexes which are different from each other. The plurality of thin films are designed in their material, number of layers, and thickness so that the desired optical characteristics (for example reflectance) are obtained. The material of each thin film is for example a dielectric. The dielectric is for example silicon dioxide (SiO₂), titanium dioxide (TiO₂), or tantalum pentoxide (Ta₂O₅). The thickness of each thin film is for example about the submicron level. Further, thickness of each thin film is made constant in the thin film, and consequently the thickness of each reflection film 5 is constant. The number of layers of the plurality of thin films is for example 10 or less. The plurality of thin films closely contact and are fixed to each other. Further, the reflection films 5 closely contact and are fixed to the light transmission body 7.

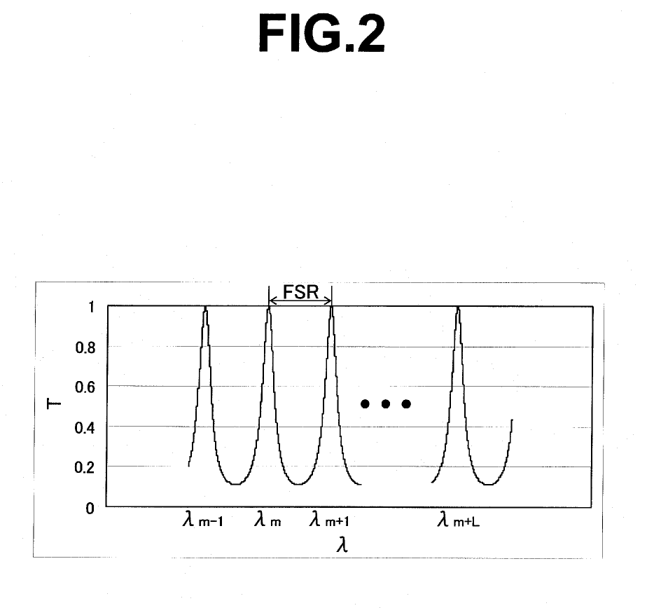

FIG. 2 is a graph which schematically shows the transmission characteristic of the etalon 1. In FIG. 2, an abscissa shows the wavelength λ, and an ordinate shows the transmission coefficient T. Note that, the transmission coefficient T is a ratio Iₒᵤₜ/Iᵢₙ between the intensity Iᵢₙ of the light Lt before incidence upon the etalon 1 and the intensity Iₒᵤₜ of the light Lt after emission from the etalon 1.

As already explained, the light Lt incident upon the etalon 1 is repeatedly reflected between a pair of reflection films 5 and is emitted from the etalon 1. Accordingly, in the etalon 1, in the same way as a conventional etalon, the transmission coefficient T cyclically rises at the m order peak wavelength λₘ (peak vibration frequency νₘ). Note that, usually, FSR is expressed by the interval (νₘ−νₘ₊₁) of the peak vibration frequency νₘ. However, in FIG. 2, for assisting understanding, FSR is shown between the peak wavelengths.

FSR is roughly expressed by the following Equation (1) by using the light path length nd of the medium sandwiched by a pair of reflection films.

$$\begin{matrix}[ math . 1 ] & \\ FSR = \frac{c}{2 nd cos θ} & ( 1 )\end{matrix}$$

where, “c” is the speed of light, “n” is the refractive index of the medium, “d” is the thickness of the medium, and θ is the refraction angle of the light in the medium.

On the other hand, in the etalon 1, the light transmitting portion 3 which forms the medium between the pair of reflection films 5 has the first light transmission body 7A which has a positive characteristic indicator and the second light transmission body 7B which has a negative characteristic indicator. Accordingly, the change of the light path length nd due to a temperature change is cancelled for at least the part between the pair of light transmission bodies 7. That is, the change of the light path length nd is suppressed for the overall light transmitting portion 3. As a result, a temperature change of the FSR caused by a temperature change is suppressed.

Preferably, a pair of light transmission bodies 7 are selected in material (refractive index) and set in thickness so that the change of the light path length nd caused by a temperature change is roughly cancelled (so that the absolute values of changes become roughly equal to each other). That is, when assuming that the change of the light path length caused by a temperature change is expressed by a linear function, roughly, the material (refractive index) is selected and the thickness is set for the pair of light transmission bodies 7 so that the following Equation (2) is satisfied.

$$\begin{matrix}[ math . 2 ] & \\ \frac{d ( {n}_{1} {d}_{1} + {n}_{2} {d}_{2} )}{d T} = 0 & ( 2 )\end{matrix}$$

where n₁ and d₁ are the refractive index and thickness of the first light transmission body 7A, n2 and d2 are the refractive index and thickness of the second light transmission body 7B, and T is the temperature.

The gap 53, reflection films 5, and anti-reflection films 9 are small in light path length, therefore the influences of the changes of the light path lengths of them due to a temperature change exerted upon the FSR are small. Therefore, it is considered that the change of light path length in these is negligible. Note, the change of the light path length in these may be added to the left side in Equation (2) for selection of the material and setting of the thickness as well.

By determination of the thickness etc. of the light transmission bodies 7 in this way, the absolute value of the wavelength/temperature characteristic of the etalon 1 is determined as for example 1 pm/° C. or less. Note that, the wavelength/temperature characteristic means the characteristic that the transmittance characteristics when the light passes through the etalon 1 change to the small wavelength side or long wavelength side according to the temperature.

(Method of Setting Thicknesses of Media)

Usually, the materials (refractive indexes) of the media (light transmission bodies 7 etc.) through which the light passes are first selected, then thicknesses of the media are set. In the following explanation, sometimes the method of setting the thicknesses will be explained predicated on the materials already having been specified.

The thicknesses of the light transmission bodies 7 and the distance of the gap 53 may be set by utilizing the known methods of designing etalons.

For example, simply speaking, the thicknesses of the light transmission bodies 7 and the distance of the gap 53 may be found so as to satisfy the above Equation (1) with respect to the desired FSR and satisfy Equation (2). Here, in Equation (1), nd is determined as for example nd=Σnᵢdᵢ (nᵢdᵢ is the light path length of each medium i through which the light Lt passes). Note that, the thicknesses of the anti-reflection films 9 and reflection films 5 are set so that the desired reflectance etc. are obtained as already explained. Note, the influence of these thicknesses exerted upon the FSR and so on may be considered as well.

As shown in the above Equation (1), generally the FSR is defined according to the medium between a pair of reflection films. However, the inventors of the present application discovered according to experiments etc. that the FSR changed if the configuration (material, number of layers, thickness, etc.) of the reflection films changed.

Therefore, the inventors of the present application devised a method of calculation of the FSR taking the influence of the reflection films 5 into account. This method of calculation is based on the matrix method by Florin Abeles. At the time of setting the thicknesses of the media, the method of calculation of the FSR of the inventors of the present application may be used in place of Equation (1) as well. Specifically, the FSR may be calculated (estimated) according to the method of calculation of the FSR of the inventors of the present application while changing the thickness of the medium in various ways to search for the thickness capable of obtaining the desired FSR.

The method of calculation of the FSR of the inventors of the present application is as follows.

The entire etalon 1 including the light transmitting portion 3 and the reflection films 5 is considered to be a multilayer structure configured by “m” layers of media. At this time, the characteristic matrix Mj of the j-th (1≦j≦m) medium is represented by the following Equations (3) and (4).

$$\begin{matrix}[ math . 3 ] & \\ {M}_{j} = [ \begin{matrix}cos {δ}_{j} & i \frac{1}{{n}_{j}} sin {δ}_{j} \\ i {n}_{j} sin {δ}_{j} & cos {δ}_{j}\end{matrix} ] & ( 3 ) \\ {δ}_{j} = 2 π {n}_{j} {d}_{j} / λ \cdot cos {θ}_{j} & ( 4 )\end{matrix}$$

Note, λ is the wavelength, nⱼ is the refractive index of the j-th medium, dⱼ is the thickness of the j-th medium, θⱼ is the refraction angle in the j-th medium, δⱼ is the phase of the j-th medium, and i is an imaginary unit.

The characteristic matrix M of the multilayer structure is expressed by a product of matrixes of the layers as shown in the following Equation (5).

$$\begin{matrix}[ math . 4 ] & \\ \begin{matrix}M = {\prod }_{j = 1}^{m} {M}_{j} \\ = [ \begin{matrix}{m}_{11} & i {m}_{12} \\ i {m}_{21} & {m}_{22}\end{matrix} ]\end{matrix} & ( 5 )\end{matrix}$$

A Fresnel reflection coefficient ρ and a Fresnel transmission coefficient τ of this multilayer structure are represented by the following Equation (6) and Equation (7).

$$\begin{matrix}[ math . 5 ] & \\ ρ = \frac{{n}_{0} {m}_{11} - {n}_{m} {m}_{22} + i ( {n}_{0} {n}_{m} {m}_{12} - {m}_{21} )}{{n}_{0} {m}_{11} + {n}_{m} {m}_{22} + i ( {n}_{0} {n}_{m} {m}_{12} + {m}_{21} )} & ( 6 ) \\ τ = \frac{2 {n}_{0}}{{n}_{0} {m}_{11} + {n}_{m} {m}_{22} + i ( {n}_{0} {n}_{m} {m}_{12} + {m}_{21} )} & ( 7 )\end{matrix}$$

Note, n₀ is the refractive index of the medium which becomes the incidence medium among the “m” layers of media, and nₘ is the refractive index of the medium which becomes the emission medium among the “m” layers of media.

According to Equation (6) and Equation (7), the reflection coefficient R and the transmission coefficient T are represented by the following Equation (8) and Equation (9).

$$\begin{matrix}[ math . 6 ] & \\ R = \frac{{( {n}_{0} {m}_{11} - {n}_{m} {m}_{22} )}^{2} + {( {n}_{0} {n}_{m} {m}_{12} - {m}_{21} )}^{2}}{{( {n}_{0} {m}_{11} + {n}_{m} {m}_{22} )}^{2} + {( {n}_{0} {n}_{m} {m}_{12} + {m}_{21} )}^{2}} & ( 8 ) \\ T = \frac{4 {n}_{0} {n}_{m}}{{( {n}_{0} {m}_{11} + {n}_{m} {m}_{22} )}^{2} + {( {n}_{0} {n}_{m} {m}_{12} + {m}_{21} )}^{2}} & ( 9 )\end{matrix}$$

Then, in the above Equation (9), using the wavelength λ as a variable, the transmission coefficient T is computed to find the maximum value, and FSR is calculated from the wavelength interval between the maximum values.

Note that, for the refractive index “n”, preferably the wavelength dispersion (wavelength dependency) is considered. For example, preferably the refractive index “n” is calculated based on the wavelength λ according to the following Equation (10).

[math. 7]

n(λ)=\sqrt{A₀+A₁λ²+A₂λ⁻²+A₃λ⁻⁴+A₄λ⁻⁶+A₅λ⁻⁸+A₆λ⁴} (10)

Note that, Aₒ to A₆ are dispersion coefficients. Note that, when absorption occurs at the substrate or thin films, preferably not only the refractive index, but also the extinction coefficient and its wavelength dependency are considered.

Further, FSR is generally found without considering the order “m” as exemplified in Equation (1). Note, if the FSR is found by taking the variation in accordance with the order “m” into account, the FSR may be found according to:

FSR=(νₘ−ν_{m+L})/L

where the number of intervals of peak vibration frequency, maximum peak vibration frequency, and minimum peak vibration frequency which are contained in the range of vibration frequency in which the etalon is used are L, νₘ, and ν_{m+L}.

Note that, it is clear from the theory itself that the method of calculation of the FSR explained above is capable of calculating the FSR with a high precision unless the refractive index is non-uniform in each medium.

(Method of Producing Etalon)

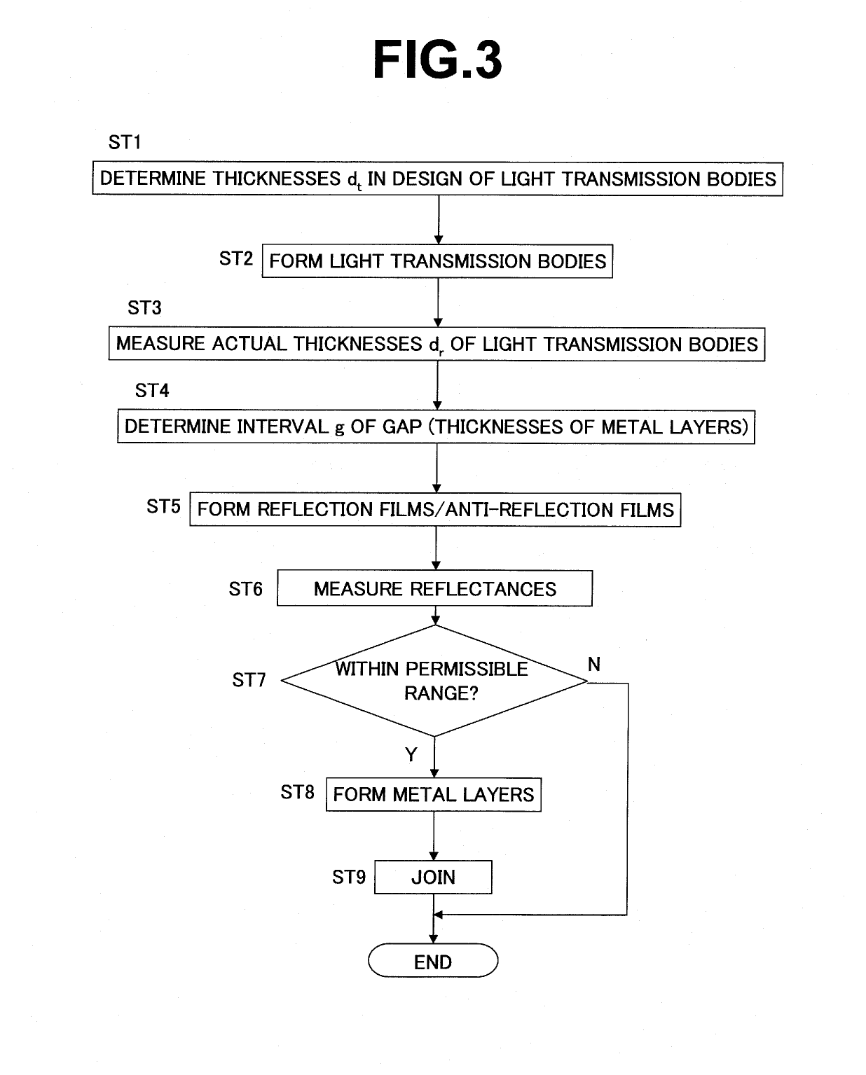

FIG. 3 is a flow chart showing the procedure of the method of producing the etalon 1.

The method of production shown in this flow chart includes as characteristic features the point of compensation for variation of machining accuracy of the light transmission bodies 7 by adjustment of the distance of the gap 53, the point that the pair of light transmission bodies 7 are not joined when a problem occurs in the formation of the anti-reflection film 9, and other points. Specifically, this is as follows.

At step ST1, the thickness dₜ in design of the light transmission bodies 7 (and the distance of the gap 53 and, if necessary, the thickness of other media) is determined. The thickness dₜ is determined as already explained so that the desired FSR is obtained (see Equation (1) or Equations (3) to (10)) and the change of the light path length with respect to the temperature change is suppressed (see Equation (2)).

At step ST2, the light transmission bodies 7 are formed. The light transmission bodies 7 are formed so that their thicknesses become the thickness dₜ in design. Note that, the method of formation of the light transmission bodies 7 may be the same as the known methods.

At step ST3, the actual thickness dᵣ of the light transmission bodies 7 formed at step ST2 is measured. The measurement may be carried out according to known methods by for example using a micrometer or laser length measuring device. Further, the measurement is preferably carried out with a precision of not more than 0.1 μm.

At step ST4, based on an actual thickness dᵣ, the interval “g” of the gap 53 is calculated again so that the desired FSR is obtained (see Equation (1) or Equations (3) to (10)). Note that, the thicknesses of the reflection films 5 and anti-reflection films 9 may be the values determined at step ST1 etc. as they are. Further, as already explained, for the change of the light path length with respect to the temperature change, the gap 53 etc. are negligible. However, the gap 53 etc. may be reconfigured by considering this change as well. In a case where a difference between the thickness dₜ in design and the actual thickness dᵣ is within a predetermined permissible range, resetting of the interval “g” need not be carried out either.

At step ST5, the reflection films 5 and anti-reflection films 9 are formed on the light transmission bodies 7. The method of film formation for them may be the same as the known methods. For example, a thin film forming method such as a physical vapor deposition process or a chemical vapor deposition process may be utilized.

At step ST6, the reflectances of the anti-reflection films 9 (and reflection films 5) are measured. The measurement may be carried out according to known methods by for example using a known photometer.

At step ST7, it is judged whether a difference between the reflectance of the anti-reflection films 9 (and reflection films 5) measured at step ST6 and the desired reflectances is within a permissible range. When it is judged as in the permissible range, the processing routine proceeds to step ST8. On the other hand, when it is judged as out of the permissible range, it is judged that the light transmission bodies 7 having that anti-reflection films 9 (or reflection films 5) formed thereon are defective and they are not joined after that.

At step ST8, a metal layer 13 is formed on each anti-reflection film 9. At this time, the thickness of the metal layer 13 is determined as the thickness corresponding to the interval “g” of the gap 53 which was determined at step ST4. The thickness of the thin film may be obtained as the desired thickness by only a thin film forming method or may be obtained as the desired thickness by polishing etc. which is carried out after the formation of a thin film.

The metal layer 13 is specifically formed by, for example, first, forming a thin film made of Cr or Ta, then forming a thin film made of Au on that. Note that, the thin film may be formed according to known methods. For example, a thin film forming method such as a physical vapor deposition process, a chemical vapor deposition process or an electroless plating may be utilized.

Further, the metal layers 13 are patterned so as to be positioned outside of the light transmission region of the light Lt. The patterning may be carried out by forming thin films which become the metal layers 13 over the entire surfaces of the anti-reflection films 9, then forming masks (for example photoresists formed by photolithography) and etching the thin films or may be carried out by arranging masks on the anti-reflection films 9 in advance, then forming thin films which become the metal layers 13.

At step ST9, a first light transmission body 7A which has a first metal layer 13A formed thereon and a second light transmission body 7B which has a second metal layer 13B formed thereon are made to abut against each other and are hot pressed to join the pair of metal layers 13 (Au layers) to each other by metal diffusion. Note that, in the formation of the metal layers 13 at step ST8, the thickness of the metal layers 13 may be adjusted by considering the change of thickness of the metal layers 13 at this time as well.

### EXAMPLES

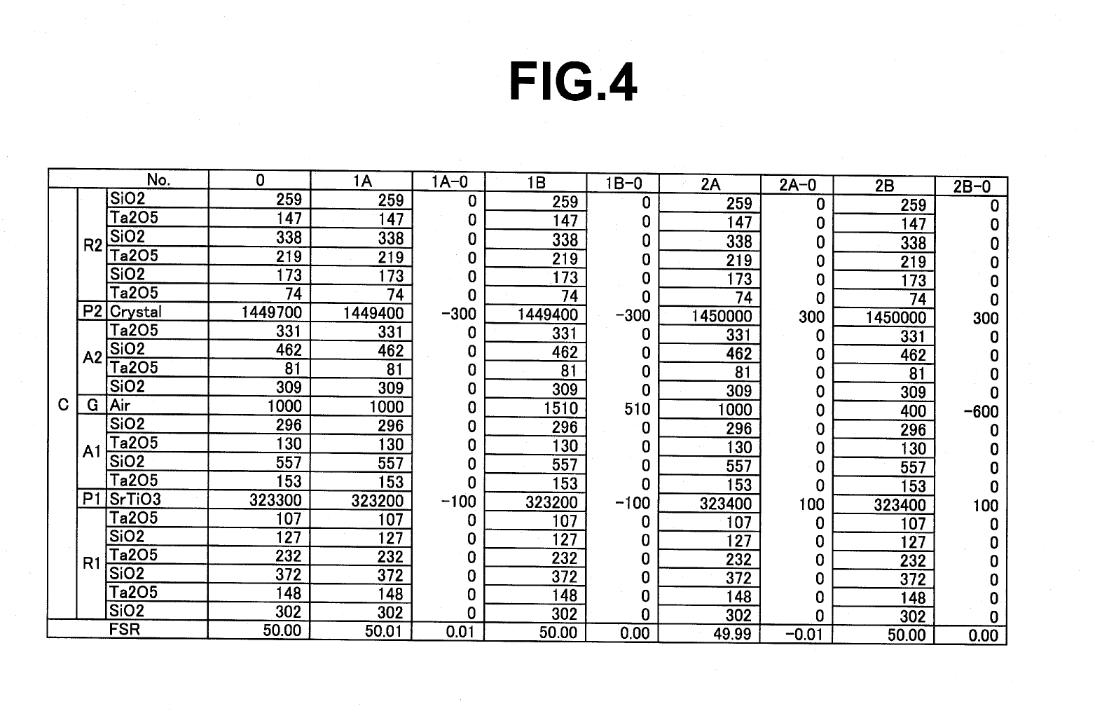

FIG. 4 is a table which shows examples of computation in a case where variation of machining accuracy of the light transmission bodies 7 is compensated for by adjustment of the distance of the gap 53 (steps ST1 to ST4).

In the example of computation in FIG. 4, 0° is assumed as the incidence angle, 1530 to 1610 nm is assumed as the wavelength range, 50% is assumed as the reflectance of the reflection film 5, and 50 GHz is assumed as the FSR (desired value). Further, it is assumed that the incidence face and emission face of the etalon 1 contact air.

In FIG. 4, each column (vertical column) corresponds to a configuration example, and each row shows a characteristic feature of each configuration example. Specifically, this is as follows.

“No.” in the uppermost row in FIG. 4 shows a number which is attached to a configuration example for convenience. Then, in FIG. 4, five types of configuration examples of No. 0, No. 1A, No. 1B, No. 2A, and No. 2B are shown. No. 1A-0, No. 1B-0, No. 2A-0, and No. 2B-0 show differences between the configuration example of No. 0 and the other configuration examples. For example, No. 1A-0 shows the difference of the configuration example of No. 1A with respect to the configuration example of No. 0.

“C” at the center in FIG. 4 combining a plurality of rows shows the configuration of the etalon 1. In “C”, “R2” indicates the configuration of the second reflection film 5B, “P2” indicates the configuration of the second light transmission body 7B, “A2” indicates the configuration of the second anti-reflection film 9B, “G” indicates the configuration of the gap 53, “A1” indicates the configuration of the first anti-reflection film 9A, “P1” indicates the configuration of the first light transmission body 7A, and “R1” indicates the configuration of the first reflection film 5A.

As shown in these rows, the first light transmission body 7A is made of quartz crystal, the second light transmission body 7B is made of strontium titanate, and the interior of the gap 53 is filled with air. Further, the reflection films 5 and anti-reflection films 9 are configured by alternate lamination of silicon dioxide and tantalum pentoxide.

In each row, in the field corresponding to each column (configuration example), the thickness of each medium (unit: nm) is shown. For example, in the configuration example of No. 0, the thickness of the second light transmission body 7B (quartz crystal) is 1449700 nm.

The row “FSR” at the lowermost level in FIG. 4 shows the values of the FSR (unit: GHz) calculated according to the method of calculation of the FSR by the inventors of the present application based on the qualities of materials and thicknesses of the media shown in the plurality of rows “C”.

In FIG. 4, No. 0 indicates the design values determined at step ST1. No. 1A indicates the values when assuming that the actual thickness dᵣ of the light transmission bodies 7 ends up becoming smaller relative to the thickness dₜ in design in No. 0 (see rows of “P2” and “P1”) when the light transmission bodies 7 are formed so that the design values of No. 0 are realized (step ST2). That is, as shown in No. 1A-0, an error of −300 nm arises for the second light transmission body 7B, and an error of −100 nm arises for the first light transmission body 7A.

In this case, when assuming that the etalon 1 is prepared leaving the interval “g” of the gap 53 (see the row of “G”) as the initial design value (the value of No. 0 as it is), the FSR of No. 1A becomes 50.01 GHz and deviates from 50.00 GHz as the desired value.

Therefore, the interval “g” of the gap 53 is reset so that the FSR becomes the target value of 50.00 GHz (step ST4). No. 1B indicates the configuration after that resetting. As shown in No. 1B-0, corresponding to the actual thickness dᵣ of the light transmission bodies 7 becoming smaller than the thickness dₜ in design, the interval “g” of the gap 53 becomes larger than the initial design value.

Note that, as shown in this example, the variation of precision of the thickness of the light transmission bodies 7 and the amount of change of the distance of the gap 53 for compensating for the variation are not much different as absolute values, but the signs are inverse.

Inverse to No. 1A, No. 2A shows the values when assuming that the actual thickness dᵣ of the light transmission bodies 7 have become larger than the thickness dₜ in design in No. 0. Then, in the same way as No. 1B, No. 2B indicates the configuration example at the time when the distance of the gap 53 is reconfigured so as to compensate for the error in No. 2A.

(Examples of Application of Etalon Filter)

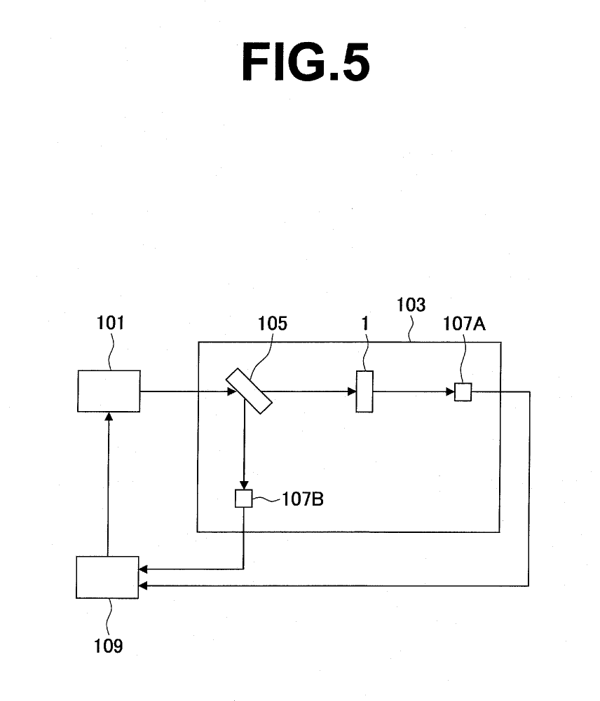

FIG. 5 is a block diagram which shows an example of application of the etalon 1.

The etalon 1 is assembled in a wavelength locker 103 for keeping the wavelength of the light of a laser system 101 constant. The wavelength locker 103 for example has a beam splitter 105 upon which the light which is dropped from the laser system 101 is incident, an etalon 1 upon which the light which is transmitted through the beam splitter 105 is incident, a first photodetector 107A upon which the light which is transmitted through the etalon 1 is incident, and a second photodetector 107B upon which the light which is reflected by the beam splitter 105 is incident. A control device 109 detects the wavelength of the light by comparing the intensity of the light which is detected by the first photodetector 107A and the intensity of the light which is detected by the second photodetector 107B and executes control of the laser system 101 so that the detected wavelength is kept constant.

By use of the etalon 1 which is adjusted in the FSR with a high precision for such a wavelength locker 103, it becomes possible to monitor the wavelength of light with a high precision.

As described above, the etalon 1 in the present embodiment has the first light transmission body 7A which causes a positive change in the light path length with respect to a temperature increase change, the second light transmission body 7B which causes a negative change in the light path length with respect to a temperature increase change, the first reflection film 5A which covers the first outer surface 51A, the first anti-reflection film 9A which covers the first inner surface 55A, the second anti-reflection film 9B which covers the second inner surface 55B, and the second reflection film 5B which covers the first outer surface 51A. Further, the first inner surface 55A and the second inner surface 55B face each other while sandwiching the gap 53 therebetween.

Accordingly, there is provided an etalon which has a new basic configuration (composite type air gap etalon) wherein the light path in which the light Lt reciprocates is configured by two light transmission bodies 7 and a gap 53. That is, there is provided an etalon having a configuration different from a solid etalon (including a conventional composite type etalon) wherein a light path through which the light goes and returns is configured by only light transmission bodies and from an air gap etalon wherein a light path through which the light goes and returns is configured by only a gap.

This composite type air gap etalon having the new basic configuration exerts various advantageous effects.

For example, in the composite type air gap etalon, in the same way as a conventional composite type etalon, a change of characteristics due to a temperature change is suppressed by combining two light transmission bodies 7. On the other hand, the anti-reflection films 9 are not sandwiched by the joined surfaces of the two light transmission bodies. Therefore, at the point of time of formation of the anti-reflection films 9 on the light transmission bodies 7 (step ST5), the characteristics of the anti-reflection films 9 after joining can be grasped (step ST6). As a result, joining of defects can be avoided (steps ST7 to ST9).

Further, for example, in the composite type air gap etalon, variation of the machining accuracy of the light transmission bodies 7 can be compensated for by adjustment of the distance of the gap 53 (steps ST1 to ST4), therefore realization of the desired FSR is facilitated.

Further, for example, in a conventional composite type etalon, a pair of light transmission bodies were joined by optical adhesion directly or indirectly through an anti-reflection film, therefore its bond strength was weak. However, in the composite type air gap etalon, it is possible to select a joining method with a high bond strength, for example, joining a pair of light transmission bodies 7 by using metal layers 13 (metal diffusion).

Further, for example, in comparison with a conventional air gap etalon, the composite type air gap etalon includes the light transmission bodies 7 having higher refractive indexes than that of air as the media configuring the light path through which the light reciprocates, therefore it is reduced in size more than the air gap etalon.

The present invention is not limited to the above embodiment and may be worked in various ways.

The materials for the light transmission bodies, reflection films, and anti-reflection films are not limited to those exemplified in the embodiment and may be suitably changed. For example, the light transmission bodies may be configured by quartz glass in place of quartz crystal, and rutile may be used in place of strontium titanate.

The fastening of the pair of light transmission bodies is not limited to one achieved by the spacer which is interposed between them. Further, the spacer is not limited to one comprised of metal and for example may be comprised of a resin-based binder. Further, the metal layer configuring the spacer does not always have to be provided on each of the light transmission bodies. A single metal layer comprised of one type of material may be interposed between the light transmission bodies as well. Conversely, the metal layer formed on each light transmission body may be formed by three or more metal layers as well.

In the method of producing an etalon, compensation of variation of the machining accuracy of the light transmission bodies by the distance of the gap and ascertainment of reflectances of the anti-reflection films before joining are not indispensable factors. Note that, the variation of machining accuracy of the light transmission bodies may be compensated for by adjusting the materials and/or film thicknesses in the reflection films and/or anti-reflection films in addition to or in place of the adjustment of the distance of the gap.

### REFERENCE SIGNS LIST

1 . . . etalon, 7A . . . first light transmission body, 7B . . . second light transmission body, 5A . . . first reflection film, 5B . . . second reflection film, 9A . . . first anti-reflection film, 9B . . . second anti-reflection film, 51A . . . first outer surface, 51B . . . second outer surface, 53 . . . gap, 55A . . . first inner surface, and 55B . . . second inner surface.

1. An etalon comprising:
a first light transmission body
which has a first outer surface which configures one of an incidence face and emission face,
which has a first inner surface of the back surface of the first outer surface, and
which causes a positive change in a light path length with respect to a temperature increase change;
a second light transmission body
which has a second outer surface which configures the other of the incidence face and the emission face,
which has a second inner surface of the back surface of the second outer surface, and
which causes a negative change in a light path length with respect to a temperature increase change;
a first reflection film which covers the first outer surface;
a first anti-reflection film which covers the first inner surface;
a second reflection film which covers the second outer surface; and
a second anti-reflection film which cover the second inner surface
wherein the first inner surface and the second inner surface face each other across a gap therebetween.

2. The etalon as set forth in claim 1, further comprising a metal layer which is interposed between the first inner surface and the second inner surface on the outer edge side of these inner surfaces and join the first light transmission body and the second light transmission body.

3. A method for producing an etalon, comprising:
a step of preparing a first light transmission body which has a first outer surface and a first inner surface of the back surface of the first outer surface and which causes a positive change in a light path length with respect to a temperature increase change,
a step of preparing a second light transmission body which has a second outer surface and a second inner surface of the back surface of the second outer surface and which causes a negative change in the light path length with respect to a temperature increase change,
a step of forming a first reflection film covering the first outer surface,
a step of forming a first anti-reflection film which covers the first inner surface,
a step of forming a second reflection film which covers the second outer surface,
a step of forming a second anti-reflection film which covers the second inner surface, and
a step of fixing the first light transmission body and the second light transmission body to each other in a state where the first inner surface which is covered by the first anti-reflection film and the second inner surface which is covered by the second anti-reflection film are made to face each other across a gap.

4. The method for producing an etalon as set forth in claim 3, further comprising
a step of measuring the thicknesses of the first light transmission body and the second light transmission body before fixing the first light transmission body and the second light transmission body to each other, wherein
in the step of fixing the first light transmission body and the second light transmission body to each other, the distance of the gap is adjusted based on the measured thicknesses of the first light transmission body and the second light transmission body.

5. The method for producing an etalon as set forth in claim 4, wherein:
in the step of fixing the first light transmission body and the second light transmission body to each other, on at least one surface between the first inner surface and the second inner surface, a metal layer is formed on the outer edge side thereof, the first light transmission body and the second light transmission body are fixed to each other by the metal layer, and the distance of the gap is adjusted according to the adjustment of the thickness when forming the metal layer.

6. The method for producing an etalon as set forth in claim 1, further comprising, before the step of fixing the first light transmission body and the second light transmission body to each other,
a step of measuring the reflectance of formed above first anti-reflection film and
a step of measuring the reflectance of formed above second anti-reflection film, wherein
the step of fixing the first light transmission body and the second light transmission body is carried out only at a time when the measured reflectances are contained within predetermined permissible ranges.
